(19) United States
(12) Patent Application Publication
(10) Pub. No.: US 2008/0211401 A1
(43) Pub. Date: Sep. 4, 2008

(54) Electron Emission Device And Manufacturing Method Of The Same

(76) Inventors: Tomonari Nakada, Saitama (JP); Nobuyasu Negishi, Saitama (JP); Kazuto Sakemura, Saitama (JP); Yoshiyuki Okuda, Saitama (JP); Saburo Aso, Saitama (JP); Atsushi Watanabe, Saitama (JP); Takamasa Yoshikawa, Saitama (JP); Kiyohide Ogasawara, Saitama (JP)

Correspondence Address: DRINKER BIDDLE & REATH (DC), 1500 K STREET, N.W., SUITE 1100, WASHINGTON, DC, 20005-1209, US

(21) Appl. No.: 11/793,063

(22) PCT Filed: Nov. 15, 2005
(86) PCT No.: PCT/JP2005/021321

§ 371 Date: Jun. 15, 2007

(30) Foreign Application Priority Data
Dec. 17, 2004 (JP) 2004-365813

(51) Int. Cl. H01J 1/62; H01J 9/02

(52) U.S. Cl. 313/509; 445/50

(57) ABSTRACT

An electron emission device including a lower electrode on a near side to a substrate and an upper electrode on a far side to the substrate and an insulator layer and an electron supply layer stacked between the lower electrode and the upper electrode and emitting an electron from the upper electrode side at the time of applying a voltage between the lower electrode and the upper electrode, which includes an electron emission part provided with an opening formed by an inner wall of a stepped shape in which a thickness of the insulator layer decreases stepwise; and a carbon-containing carbon region which is connected to the upper electrode side and which is brought into contact with the insulator layer and the electron supply layer.

### TECHNICAL FIELD

The present invention relates to an electron emission device as an electron source and a manufacturing method of the same.

### BACKGROUND ART

As a structure of an electron emission device of a surface electron source, a metal-insulator-semiconductor (MIS) type, a metal-insulator-metal (MIM) type, and the like have hitherto been known.

For example, in an example of an electron emission device of an MIM structure, there is a structure in which a lower electrode, an insulator layer and an upper electrode are stacked in this order on a substrate. Examples thereof include a structure in which an Al layer as a cathode lower electrode, an Al₂O₃ insulator layer having a thickness of approximately 10 nm and an anode upper electrode having a thickness of approximately 10 nm are formed in this order on a substrate. When this is disposed beneath a counter electrode in a vacuum and a prescribed voltage is applied between the lower electrode and the upper electrode, a part of electrons flies out in a vacuum from the upper electrode.

However, an electron emission device of an MIM structure in which an electron emission part occupying a large area within the device is formed of a stack structure of a thin insulating layer and a thin upper electrode involves a drawback that leakage of a current is easy to occur at the time of turning on electricity due to a defect generated at the time of fabrication or the like, whereby breakage of the device is easy to occur. In order to solve such a problem, a method of forming an area having an extremely thin insulating layer which becomes an electron emission part within the electron emission device in a necessary and minimum size is proposed. For example, the preparation of an electron emission device by using a fine particle 20 as illustrated in FIG. 1 or a reverse taper block 21b as illustrated in FIG. 2 to form an electron emission part is corresponding thereto (see WO 03/049132 A1). Though the electron emission part is prepared by using a fine particle or a micro mask, in the case of a fine particle, it is difficult to put the fine particle in an aimed place, and it is impossible to perform its dispersion ideally. In the case of a device having plural electron emission parts, since the electron emission amount is in proportion to the number of electron emission parts, for example, in forming a fine electron emission device or electron emission device array of not more than 100 mm, a method of using a fine particle is difficult with respect to the control of the electron emission amount and is not suitable. On the other hand, in the case of preparing a micro mask by employing photolithography, though it is suitable for a fine electron emission device or electron emission device array, a process of forming a micro mask is complicated, and the control of an electron emission part shape is difficult. Also, a method according to a micro mask involves a problem that an insulator layer or upper electrode adhered to the mask becomes a particle without being removed, thereby contaminating production equipment. In particular, in order to make the electron emission device fine, the preparation by a semiconductor process is essential, and the formation and production of a micro mask by a general semiconductor production line is not suitable.

### DISCLOSURE OF THE INVENTION

Then, a problem that the invention is to solve is to provide an electron emission apparatus for forming an electron emission part capable of stably emitting an electron and a manufacturing method of the same.

The electron emission device of the invention is an electron emission device including a lower electrode on a near side to a substrate and an upper electrode on a far side to the foregoing substrate and an insulator layer and an electron supply layer stacked between the foregoing lower electrode and the foregoing upper electrode and emitting an electron from the foregoing upper electrode side at the time of applying a voltage between the foregoing lower electrode and the foregoing upper electrode, which is characterized by including

an electron emission part provided with an opening formed by an inner wall of a stepped shape in which a thickness of the foregoing insulator layer decreases stepwise; and a carbon-containing carbon region which is connected to the foregoing upper electrode side and which is brought into contact with the foregoing insulator layer and the foregoing electron supply layer.

An electron emission device array of the invention is characterized by including a plurality of the foregoing electron emission devices.

The manufacturing method of an electron emission device of the invention is a manufacturing method of an electron emission device including a lower electrode on a near side to a substrate and an upper electrode on a far side to the foregoing substrate and an insulator layer and an electron supply layer stacked between the foregoing lower electrode and the foregoing upper electrode and emitting an electron from the foregoing upper electrode side at the time of applying a voltage between the foregoing lower electrode and the foregoing upper electrode, which is characterized by including

an electron emission part forming step of uniformly fabricating the foregoing insulator layer and the foregoing upper electrode, removing a part of the foregoing insulator layer and the foregoing upper electrode to decrease stepwise a thickness of the foregoing insulator layer and form an opening having an inner wall in a stepped shape, and exposing the foregoing electron supply layer; and

a carbon region forming step of fabricating a carbon-containing carbon region which is connected to the foregoing upper electrode side and which is brought into contact with the foregoing insulator layer and the foregoing electron supply layer.

### BRIEF DESCRIPTION OF THE DRAWINGS

FIGS. 1 and 2 are each an outline cross-sectional view of a conventional electron emission device.

FIG. 3 is a partial enlarged cross-sectional view of an electron emission device of an embodiment according to the invention.

FIG. 4 is a partial enlarged oblique view of an electron emission device array of an embodiment according to the invention.

FIGS. 5 to 14 are each a partial enlarged cross-sectional view of an electron emission device to explain a manufacturing step of an electron emission device of an embodiment according to the invention.

FIG. 15 is a plan view of an electron emission part of an electron emission device of an embodiment according to the invention.

FIGS. 16 and 17 are each a plan view of an electron emission part of an electron emission device of other embodiment according to the invention.

FIG. 18 is a partial enlarged cross-sectional view of an electron emission device of other embodiment according to the invention.

FIG. 19 is an outline view to explain a measurement system of an electron emission device of an embodiment according to the invention.

FIG. 20 is a graph to show a current-voltage characteristic of an Example according to the invention.

FIG. 21 is a graph to show a current-voltage characteristic after an activation treatment of an Example according to the invention.

FIGS. 22 and 23 are each a graph to show an emission current amount and a breakage rate of device versus a thickness of an insulator layer of an electron emission device according to other Example of the invention.

FIG. 24 is a partial enlarged cross-sectional view to explain an electron emission device according to other Example of the invention.

FIG. 25 is a graph to show a relation of an emission current amount versus a number of steps of a thickness of an insulator layer of an electron emission device according to other Example of the invention.

FIG. 26 is a partial enlarged cross-sectional view to explain an electron emission device of other Example of the invention.

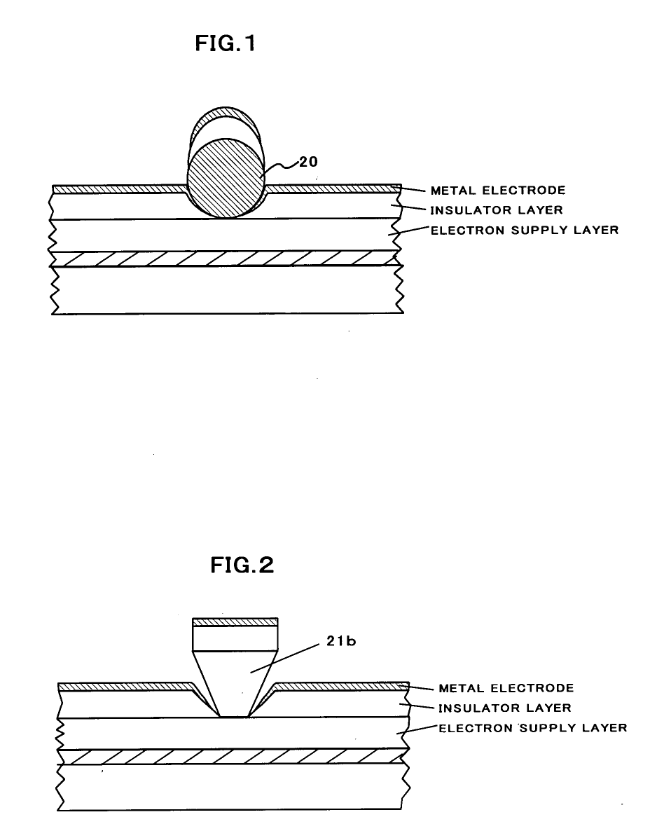

### DETAILED DESCRIPTION OF THE INVENTION

Embodiments of the invention are hereunder described with reference to the drawings.

### [Electron Emission Apparatus]

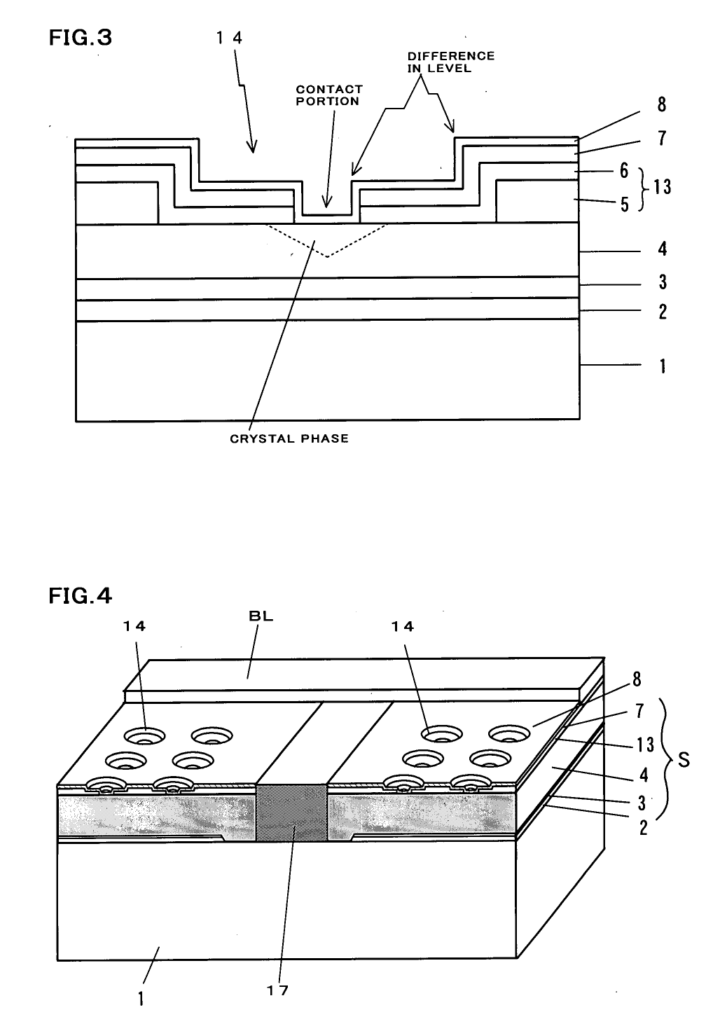

FIG. 3 shows an outline cross-sectional view of an example of an electron emission device of the invention. An electron emission device S is composed of a barrier layer 3, an electron supply layer 4, an insulator layer 13 (thick insulator part 5 and thin insulator part 6), an upper electrode 7, and a carbon region 8 stacked and formed in this order on a lower electrode 2 from the near side as formed on a substrate 1. The electron emission device includes an opening in which the insulator layer 13 is formed by an inner wall of a stepped shape; such an opening functions as an electron emission part 14; and at the time of applying a prescribed voltage between the lower electrode 2 and the upper electrode 7, an electron is emitted from a side of the upper electrode 7. For example, the electron emission part 14 is a region in which a thickness of the insulator layer 13 composed of the thick insulator part 5 and the thin insulator part 6 decreases stepwise toward a center thereof, and at least one difference in level is present. Each of the thick insulator part 5 and the thin insulator part 6 can be fabricated as a single-layer or multilayered structure. The electron emission part 14 is formed as a recess on a flat surface of the upper electrode 7. Also, the thin insulator part 6 in the electron emission part 14 is terminated at an edge on the electron supply layer 4. In the electron emission part 14, the upper electrode 7 is terminated at an edge on the thin insulator layer 6. Thus, at the time of manufacture, the upper electrode 7 and the electron supply layer 4 do not cause a short circuit. It is desirable that the electron emission part is present in a plural number within the electron emission device. This is because by arraying the electron emission part, scattering of the electron emission part is averaged, and in its turn, scattering of the electron emission device is reduced, and stability is improved.

In the electron emission part 14, the carbon region 8 is brought into contact with the electron supply layer 4 while coming into contact with the thin insulator part 6 from the side of the upper electrode 7 (contact portion). A thickness of the insulator layer composed of the thick insulator part 5 and the thin insulator part 6 decreases stepwise toward a portion where the carbon region 8 and the electron supply layer 4 come into contact with each other and becomes zero.

FIG. 4 shows an electron emission device array having a plurality of the electrode emission devices S. In this electron emission device array, the plural electron emission devices S are arranged in, for example, a matrix state. A bus line BL for connecting the adjacent upper electrode 7 and the lower electrode 2 are each made as an electrode in a stripe state and are arranged in a position orthogonal to each other. The electron emission device S is disposed at a point of intersection of the stripes. The electron emission devices S are partitioned from each other by a portioning insulating part 17.

In each of the electron emission devices S, the barrier layer 3, the electron supply layer 4, the thick insulator part 5, the thin insulator part 6, the upper electrode 7, and the carbon region 8 are stacked in this order on the device substrate 1. As a material of the device substrate 1, besides glass, ceramics such as Al₂O₃, Si₃N₄, and BN may be used. A wafer resulting from covering a Si wafer by an insulating film such as SiO₂ is also useful as the substrate.

The lower electrode 2 is composed of a single layer or multiple layers and made of, for example, aluminum (Al), tungsten (W), copper (Cu), or chromium (Cr).

The barrier layer 3 is made of a metal barrier such as titanium nitride (TiN).

The electron supply layer 4 is composed of an amorphous phase of silicon (Si) or a mixture containing Si as a major component or a compound thereof, or a semiconductor of a single crystal layer or a polycrystal layer. As a material of the electron supply layer 4, though amorphous silicon (a-Si) doped with an element of the group IIIb or group Vb as fabricated by a sputtering method or a CVD method is especially effective, compound semiconductors such as hydrogenated amorphous silicon (a-Si:H) resulting from terminating a dangling bond of a-Si with hydrogen (H) and hydrogenated amorphous silicon carbide (a-SiC:H) resulting from further substituting a part of Si with carbon (C) or hydrogenated amorphous silicon nitride (a-SiN:H) resulting from further substituting a part of Si with nitrogen (N) are useful, too.

As a dielectric material of the thin insulator part 6, though silicon oxide SiOₓ (subscript x represents an atomic ratio) is especially effective, oxides or nitrides such as LiOₓ, LiNₓ, NaOₓ, KOₓ, RbOₓ, CsOₓ, BeOₓ, MgOₓ, MgNₓ, CaOₓ, CaNₓ, SrOₓ, BaOₓ, ScOₓ, YOₓ, YNₓ, LaOₓ, LaNₓ, CeOₓ, PrOₓ, NdOₓ, SmOₓ, EuOₓ, GdOₓ, TbOₓ, DyOₓ, HoOₓ, ErOₓ, TmOₓ, YbOₓ, LuOₓ, TiOₓ, ZrOₓ, ZrNₓ, HfOₓ, HfNₓ, ThOₓ, VOₓ, VNₓ, NbOₓ, NbNₓ, TaOₓ, TaNₓ, CrOₓ, CrNₓ, MoOₓ, MoNₓ, WOₓ, WNₓ, MnOₓ, ReOₓ, FeOₓ, FeNₓ, RuOₓ, OsOₓ, CoOₓ, RhOₓ, IrOₓ, NiOₓ, PbOₓ, PtOₓ, CuOₓ, CuNₓ, AgOₓ, AuOₓ, ZnOₓ, CdOₓ, HgOₓ, BOₓ, BNₓ, AlOₓ, AlNₓ, GaOₓ, GaNₓ, InOₓ, SiNₓ, GeOₓ, SnOₓ, PbOₓ, POₓ, PNₓ, AsOₓ, SbOₓ, SeOₓ, and TeOₓ may be used, too.

Also, composite oxides such as LiAlO₂, Li₂SiO₃, Li₂TiO₃, Na₂Al₂₂O₃₄, NaFeO₂, Na₄SiO₄, K₂SiO₃, K₂TiO₃, K₂WO₄, Rb₂CrO₄, CS₂CrO₄, MgAl₂O₄, MgFe₂O₄, MgTiO₃, CaTiO₃, CaWO₄, CaZrO₃, SrFe₁₂O₁₉, SrTiO₃, SrZrO₃, BaAl₂O₄, BaFe₁₂O₁₉, BaTiO₃, Y₃Al₅O₁₂, Y₃Fe₅O₁₂, LaFeO₃, La₃Fe₅O₁₂, La₂Ti₂O₇, CeSnO₄, CeTiO₄, Sm₃Fe₅O₁₂, EuFeO₃, Eu₃Fe₅O₁₂, GdFeO₃, Gd₃Fe₅O₁₂, DyFeO₃, Dy₃Fe₅O₁₂, HoFeO₃, Ho₃Fe₅O₁₂, ErFeO₃, Er₃Fe₅O₁₂, Tm₃Fe₅O₁₂, LuFeO₃, Lu₃Fe₅O₁₂, NiTiO₃, Al₂TiO₃, FeTiO₃, BaZrO₃, LiZrO₃, MgZrO₃, HfTiO₄, NH₄VO₃, AgVO₃, LiVO₃, BaNb₂O₆, NaNbO₃, SrNb₂O₆, KTaO₃, NaTaO₃, SrTa₂O₆, CuCr₂O₄, Ag₂CrO₄, BaCrO₄, K₂MoO₄, Na₂MoO₄, NiMoO₄, BaWO₄, Na₂WO₄, SrWO₄, MnCr₂O₄, MnFe₂O₄, MnTiO₃, MnWO₄, CoFe₂O₄, ZnFe₂O₄, FeWO₄, CoMoO₄, CoTiO₃, CoWO₄, NiFe₂O₄, NiWO₄, CuFe₂O₄, CuMoO₄, CuTiO₃, CuWO₄, Ag₂MoO₄, Ag₂WO₄, ZnAl₂O₄, ZnMoO₄, ZnWO₄, CdSnO₃, CdTiO₃, CdMoO₄, CdWO₄, NaAlO₂, MgAl₂O₄, SrAl₂O₄, Gd₃Ga₅O₁₂, InFeO₃, MgIn₂O₄, Al₂TiO₅, FeTiO₃, MgTiO₃, Na₂SiO₃, CaSiO₃, ZrSiO₄, K₂GeO₃, Li₂GeO₃, Na₂GeO₃, Bi₂Sn₃O₉, MgSnO₃, SrSnO₃, PbSiO₃, PbMoO₄, PbTiO₃, SnO₂-Sb₂O₃, CuSeO₄, Na₂SeO₃, ZnSeO₃, K₂TeO₃, K₂TeO₄, Na₂TeO₃, and Na₂TeO₄; sulfides such as FeS, Al₂S₃, MgS, and ZnS; fluorides such as LiF, MgF₂, and SmF₃; chlorides such as HgCl, FeCl₂, and CrCl₃; bromides such as AgBr, CuBr, and MnBr₂; iodides such as PbI₂, CuI, and FeI₂; lanthanoid borides such as LaB₆ and CeB₆; metal borides such as TiB₂, ZrB₂, and HfB₂; and composite oxynitrides such as SiAlON are also effective as the dielectric material of the thin insulator part 6.

Also, diamond and carbon insulators made of a fullerene (C2n) are effective.

Though a thickness of a flat portion other than the electron emission part 14 of the thin insulator part is preferably 50 nm or more, its more preferred thickness range is determined by a capacitance of the device.

In the flat part of the device, the thin insulator part interposed between the upper electrode and the electron supply layer forms a capacitance. When this capacitance value is large, a high-speed action of the device is disturbed, and in particular, in the case of combining with a photoelectric conversion film to configure an imaging apparatus, such is remarkable. From this viewpoint, it is preferable that the thick insulator part is thick.

As a material of the upper electrode 7 which is fabricated as a thin film, though tungsten (W) having an extremely high melting point is especially effective, molybdenum (Mo), rhenium (Re), tantalum (Ta), osmium (Os), iridium (Ir), ruthenium (Ru), rhodium (Rh), vanadium (V), chromium (Cr), zirconium (Zr), platinum (Pt), titanium (Ti), palladium (Pd), iron (Fe), yttrium (Y), cobalt (Co), and nickel (Ni), each of which has a high melting point, are also effective; and Au, Be, B, C, Al, Si, Sc, Mn, Cu, Zn, Ga, Nb, Tc, Ag, Cd, In, Sn, Tl, Pb, La, Ce, Pr, Nd, Pm, Sm, Eu, Gd, Tb, Dy, Ho, Er, Tm, Yb, Lu, and the like can be used, too. Also, alloys of these metals and compounds having conductivity, for example, LaB₆, CeB₆, TiB₂, ZrB₂, and HfB₂ can be used.

As a fabrication method in the manufacture of an electron emission device, a physical vapor deposition method or a chemical vapor deposition method is employable. Examples of a method which is known as the physical vapor deposition (PVD) method include a vacuum vapor deposition method, a molecular beam epitaxy method, a sputtering method, an ionization vapor deposition method, and a laser abrasion method. Examples of a method which is known as the chemical vapor deposition (CVD) method include a thermal CVD method, a plasma CVD method, and a metal organic CVD (MOCVD) method. Of these, a sputtering method is especially effective. The electron supply layer is fabricated by employing a sputtering method (inclusive of reactive sputtering) under a sputtering condition at a gas pressure of from 0.1 to 100 mTorr, and preferably from 0.1 to 20 mTorr and at a fabrication rate of from 0.1 to 1,000 nm/min, and preferably from 0.5 to 100 nm/min.

Furthermore, in the electron emission device S, though the carbon region 8 made of carbon or a mixture containing carbon as a major component or a carbon compound is fabricated on at least the electron emission part 14 as the recess thereon, this crystallizes a part of the electron supply layer 4 or the like from an amorphous phase into a crystal phase by utilizing a generated Joule heat by an activation treatment by applying a prescribed voltage between the upper and lower electrodes at the time of preparation.

The activation treatment in this device and a mechanism of electron emission thereby are thought as follows:
(1) When a direct current voltage is applied between the upper electrode 7 and the lower electrode 2, an electron runs in a route of the barrier layer 3 to the electron supply layer 4 to the carbon region 8 to the upper electrode 7 from the lower electrode 2. Alternatively, since the thin insulator part 6 formed by sputtering has a large impurity level, a hopping current passes via this impurity level. That is, there is also an electron running route of the lower electrode 2 to the barrier layer 3 to the electron supply layer 4 to the thin insulator part 6 to the upper electrode 7. Here, in a central portion of the electron emission part 14, the upper electrode 7 and the electron supply layer 4 are electrically connected to each other via the thin carbon region 8. Also, it is desirable that the application of a direct current voltage is increased gradually from 0 V. Also, the current due to the matter that an electron injected from the electron supply layer 4 runs to the upper electrode 7 in this way is called as a device current Id.
(2) Since the electron supply layer 4 made of Si of an amorphous phase has a high resistivity value, as the current increases, the heat generation occurs, whereby a part of amorphous Si of the electron supply layer is crystallized due to the subject heat.
(3) Since the portion crystallized in the electron supply layer has lower resistivity than other amorphous Si portion, the current is easy to flow. Also, an electron is trapped in the impurity level of the thin insulator part 6 and works as a fixed charge. As a result, an electric field on a near side to the upper electrode 7 of the thin insulator part 6 is extremely strengthened. On the other hand, the contact state between the carbon region and the electron supply layer becomes worse due to an influence of the heat, and the current hardly flows.
(4) As a result, the electron is concentrated into the running route of the lower electrode 2 to the barrier layer 3 to the electron supply layer 4 to the crystal phase in the electron supply layer to the thin insulator part 6. The electron is accelerated by a very strong electric field formed on a near side to the upper electrode 7 during running through the thin insulator part 6, becomes an electron having high energy called as a hot electron and tunnels through the upper electrode 7 and the carbon region 8, whereby it is emitted externally. The current due to the matter that the electron which has flown in from the electron supply layer is emitted externally and runs to an anode (not illustrated) opposing to the carbon region 8 in this way is called as an emission current Ie. The process as described previously is called as an activation treatment.

During the activation treatment, a heat is generated to such a degree that Si of the amorphous phase is transferred into a crystal phase due to the Joule heat as described previously. For that reason, when the upper electrode 7 and the electron supply layer 4 made of Si of the amorphous phase are brought into contact with each other, the metal atom of the upper electrode is diffused into Si of the amorphous phase as the electron supply layer to cause a rapid reduction of the resistivity, resulting in breakage due to an excess current. Accordingly, in the central portion of the electron emission part 14, it is important that the upper electrode 7 and the electron supply layer 4 are electrically connected to each other via the thin carbon region 8 as described previously.

In the light of the above, not only a proportion occupied by the electron emission part to the device area is made small as compared with a conventional MIM or MIS type device, but also the present electron emission device strengthens and utilizes an electric field due to concentration of a current route utilizing crystallization of the amorphous phase via the activation treatment or trapping into the impurity level in the thin insulator layer. As a result, even when a practical electron emission part is made small, the electron emission amount per the device area, namely the emission current density becomes equal to or more than that of the conventional MIM or MIS type.

As a material of the carbon region, carbon in a form of, for example, amorphous carbon, graphite, Calvin, fullerene (C2n), diamond-like carbon, carbon nanotube, carbon nanofiber, carbon nanohorn, carbon nanocoil, carbon nanoplate, or diamond, or carbon compounds such as ZrC, SiC, WC, and MoC are effective.

With respect to a method of forming the carbon region as a thin film, for example, the carbon region can be uniformly stacked and formed on the electron emission part as the recess part and the upper electrode by a sputtering apparatus having a carbon target provided in a vacuum chamber or the like. In that case, carbon mainly takes a form such as amorphous carbon, graphite, and diamond-like carbon. On the other hand, in the case where carbon of the carbon region takes a form such as carbon nanotube, carbon nanofiber, carbon nanohorn, carbon nanocoil, and carbon nanoplate, a CVD method is effective. In that case, a catalyst layer containing Fe, Ni, or Co as a major component can be provided as a surface layer of the upper electrode. Alternatively, a printing method is also effective as a formation method of the carbon region irrespective of the form of carbon.

Furthermore, in the electron emission device of the present embodiment, since the thin insulator part other than the electron emission part has a thick thickness, a through-hole is hardly generated, and a production yield is improved. Also, the electron emission device of the present embodiment can be applied to a display, a light source of pixel valve, an imaging device, an electron emission source of an electron microscope or the like, and a high-speed device such as a vacuum micro electronics device; and furthermore, it is able to act as a planar or point-like electron emission diode and further as a high-speed switching device.

In particular, in the case of an electron emission source of a small-sized high-definition display or an electron emission source of an imaging device, it is required to configure fine pixels of approximately 20 mm, and therefore, the electron emission device of the present embodiment is effective.

### [Manufacturing Method of Electron Emission Apparatus]

An example of the manufacturing method of an electron emission apparatus is described in outline.

First of all, as illustrated in FIG. 5, a clean substrate 1 is prepared; and a stack composed of a lower electrode 2 of a metal electrode made of, for example, Al or Cr/Cu/Cr multiple layers and a barrier layer 3 made of a barrier metal such as TiN is fabricated in a stripe form on a principal surface thereof. Here, these can be fabricated on a Si substrate having formed thereon an oxide film by thermal oxidation by sputtering. Also, TiN can be fabricated by reactive sputtering with nitrogen being introduced thereinto.

Next, as illustrated in FIG. 6, an electron supply layer 4 made of, for example, Si is uniformly formed on the exposed substrate 1 and the barrier layer 3 by sputtering. Besides Si, an electron supply layer made of a mixture containing Si as a major component or a compound thereof can be formed on the substrate, too. For example, amorphous Si of an electron supply layer having boron (B) added thereto can be fabricated by magnetron sputtering.

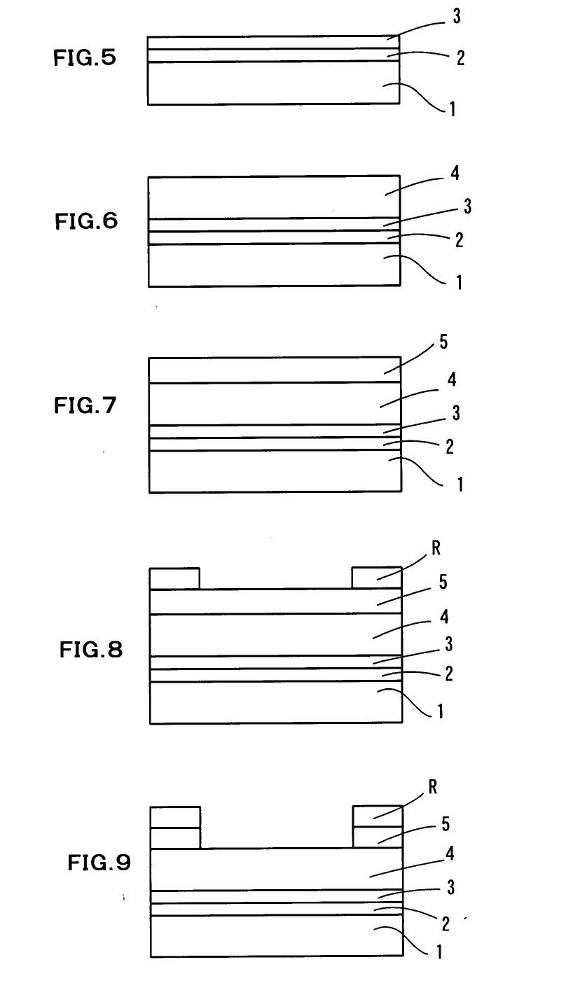

Next, as illustrated in FIG. 7, an insulator such as SiOₓ is fabricated on the electron supply layer 4 by reactive sputtering with oxygen being introduced thereinto, thereby uniformly forming a thick insulator part 5.

Thereafter, as illustrated in FIG. 8, a resist mask R is formed on the thick insulator part 5. That is, a resist is coated and subjected to patterning in a prescribed pattern by exposure and development. This step is composed of a process including resist coating, exposure, development and post baking similar to a usual photolithography method. Also, finer patterning can be achieved by employing an electron beam lithography method. The resist mask R is located in an upper part of the lower electrode 2 and disposed within a region to be intersected with a stripe of an upper electrode to be formed later. Here, the patterning of the resist can be formed in a circle or an outer ring such that a penetrating opening which should become an electron emission part reaches the electron supply layer 4 and is exposed.

Thereafter, as illustrated in FIG. 9, the exposed thick insulator part 5 is removed by wet etching or the like, thereby demarcating an edge part of the thick insulator part 5 which becomes a basis of a step part of the electron emission part. Also, anisotropic etching such as reactive ion etching can be carried out, too.

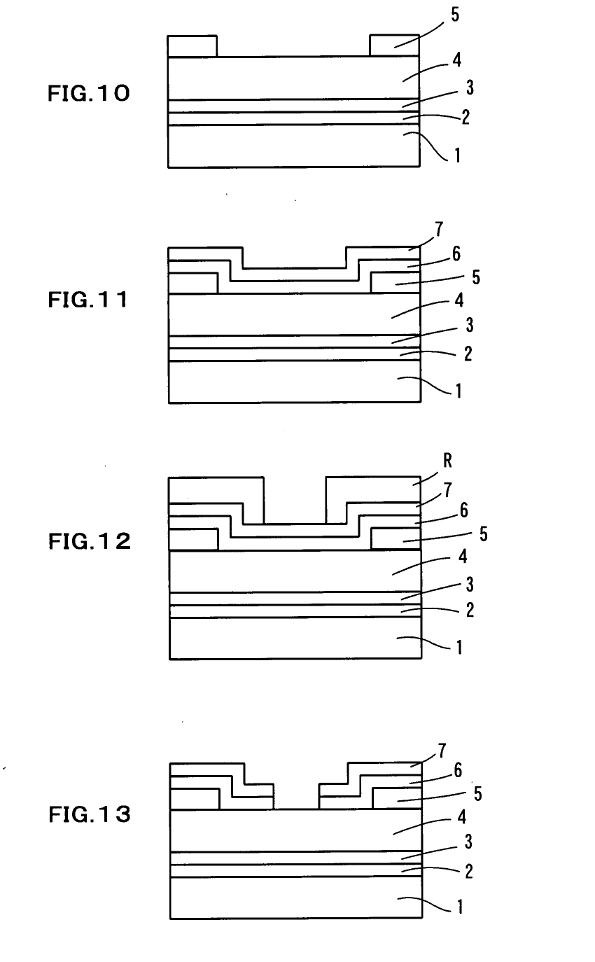

Next, as illustrated in FIG. 10, the remaining resist mask R is removed by rinsing or ashing or the like.

Next, as illustrated in FIG. 11, an insulator such as SiOₓ is fabricated on the exposed electron supply layer 4 and the thick insulator part 5 by reactive sputtering with oxygen being introduced thereinto, thereby uniformly forming a thin insulator part 6. Thereafter, an upper electrode 7 is uniformly fabricated on the thin insulator part 6 by sputtering or the like.

Thereafter, as illustrated in FIG. 12, a resist mask R is formed on the upper electrode 7. Similar to the case of FIG. 8, patterning is carried out. The resist mask R can be formed in a circle or an outer ring as a second penetrating opening coaxial with the penetrating opening of the thick insulating part 5 which should become an electron emission part and having a smaller size than the former penetrating opening such that it reaches the electron supply layer 4 and is exposed.

Thereafter, as illustrated in FIG. 13, the exposed upper electrode 7 is removed by dry etching or the like; and furthermore, the thin insulator part 6 is removed, thereby not only demarcating an edge part of the thin insulator part 6 which becomes a basis of a step part of the electron emission part but also exposing the electron supply layer 4 by the second penetrating opening. Also, isotropic or anisotropic etching such as wet or reactive ion etching can be carried out, too. Then, the remaining resist mask R is removed by rinsing or ashing or the like.

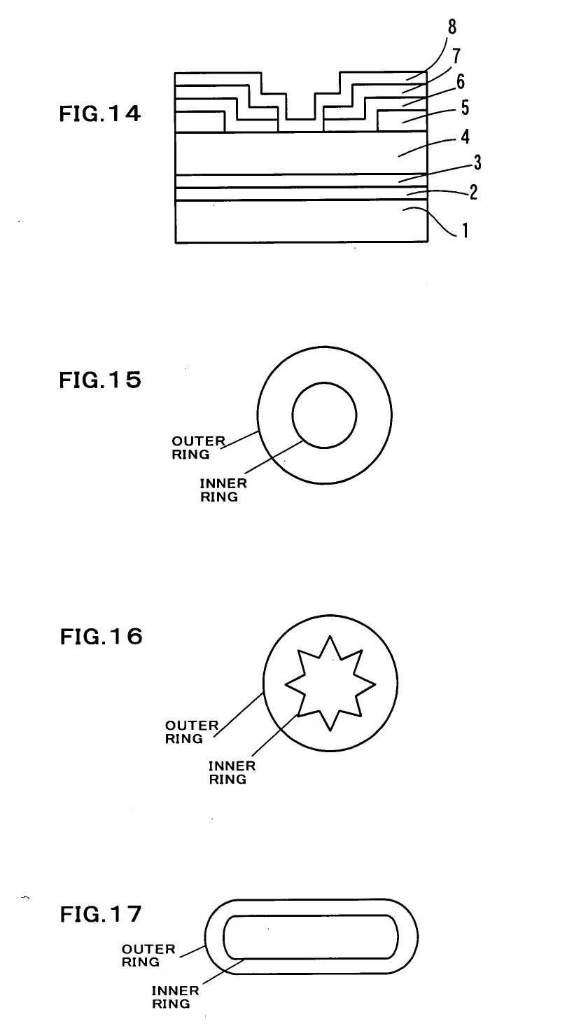

Then, as illustrated in FIG. 14, a carbon region 8 made of carbon or a mixture containing carbon as a major component or a carbon compound is uniformly fabricated on the exposed electron supply layer 4, the thin insulator part 6 and the upper electrode 7 by sputtering, and the foregoing activation treatment is then carried out, thereby completing an electron emission part.

### [Modification Example of Electron Emission Part]

In at least one of a portion where the carbon region 8 and the electron supply layer 4 are brought into contact with each other and a terminal portion of the upper electrode 7, the electron emission part 14 may be configured of a polygon or a form configured of a curve and a straight line in addition to a circle as illustrated in FIG. 15. As described previously, though the emitted electron is concentrated into a running route of the lower electrode 2 to the barrier layer 3 to the electron supply layer 4 to a crystal phase in the electron supply layer to the thin insulator part 6, this running route is formed in a form along the foregoing second penetrating opening. That is, with respect to the electron emission amount, a circumferential length of the second penetrating opening is important rather than the area of the thin insulator part. For example, in the case of a star shape as illustrated in FIG. 16, in the case of a longitudinal linear shape (or ellipse or oval) as illustrated in FIG. 17, or in the case of a cross shape, in comparison with a circle, a circumferential length of the second penetrating opening can be taken large against the area of the same thin insulator part, and a larger emission current can be obtained.

### EXAMPLE 1

The following is an example of a preparation method of the foregoing electron emission device.
(1) Al as a metal electrode and TiN as a barrier layer were fabricated on a Si substrate having formed thereon an oxide film by thermal oxidation by sputtering. On that occasion, the TiN barrier layer was fabricated by reactive sputtering with nitrogen being introduced thereinto.
(2) Si having added thereto B in a proportion of 1.1% was fabricated in a thickness of 8 mm on the TiN barrier layer by magnetron sputtering, thereby forming an amorphous Si electron supplying layer.
(3) SiOₓ was fabricated in a thickness of 300 nm on the amorphous Si layer having B added thereto on the amorphous Si electron supply layer by reactive sputtering with oxygen being introduced thereinto, thereby forming a SiOₓ thick insulator part.
(4) An outer ring was patterned on the SiOₓ thick insulator part through steps of coating of a photoresist, pre-baking, exposure, development and post baking. On that occasion, the outer ring was patterned into a circle having a diameter of 2 mm.
(5) An outer ring of the SiOₓ thick insulator part for exposing the amorphous Si electron supply layer in a center thereof was formed by wet etching.
(6) The resist was removed.
(7) On the exposed amorphous Si electron supply layer and SiOₓthin insulator part, SiOₓwas fabricated by reactive sputter etching with oxygen being introduced thereinto to form a SiOₓthin insulator part of 50 nm, and W was successively fabricated thereon by sputtering to form a W upper electrode of 60 nm.
(8) An inner ring was patterned on the W layer as the upper electrode through coating of a photoresist on the W upper electrode, pre-baking, exposure, development and post baking. On that occasion, the inner ring was patterned into a circle having a diameter of 1 mm.
(9) The W upper electrode and the SiOₓ thin insulator part were etched by dry etching to form an inner ring for exposing the amorphous Si electron supply layer in a center thereof, and the resist was removed.
(10) A carbon region was fabricated on the exposed amorphous Si electron supply layer and SiOₓthin insulator part by sputtering, followed by an activation treatment, thereby completing an electron emission part.

Here, it is noticeable that in the step (4) of forming an outer ring on the preceding insulator layer, by providing a wall part of the outer ring in a shape of a taper or multiple steps, the disconnection of the upper electrode 7 in the later steps can be prevented, thereby obtaining stable electron emission. A condition of the preparation method of an outer ring is shown below.

The patterning was carried out by exposure, development of the resist, dipping in BHF (HF+NH4F) for one minute 15 seconds, washing with water, dipping in BHF for 45 seconds and washing with water.

Since at the first wet etching, adhesion at an interface between the resist and PTEOS (phenyltriethoxysilane) is reduced and an interface etching rate increases, tapering is applied. Besides, tapering can also be achieved by one-time wet etching by fabricating PTEOS in a thickness of 1,000 angstroms, stabilizing with an N2 gas at 430° C. for 30 minutes (for making a BHT etching rate slow), subsequently fabricating PTEOS in a thickness of 2,000 angstroms without applying stabilization to form, as an upper layer, PTEOS (as grown) to which only fabrication with a fast BHT etching rate has been applied.

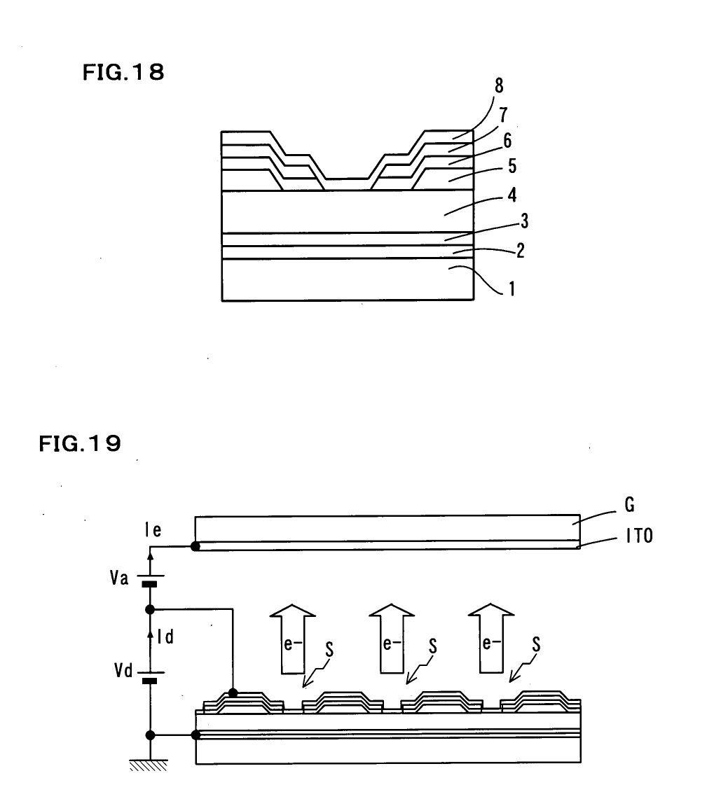

Thus, the electron emission device may be configured in the same embodiment as described previously, except that at least a part of the inner wall has a tapered structure such that in the inner wall in a stepped shape, the thickness decreases stepwise toward the contact portion of the carbon region 8 and becomes zero, as illustrated in FIG. 18.

An outline view of a measurement system of the electron emission device prepared by the present Example is shown in FIG. 19. Electron emission device arrays S of 40 mm`40 mm were prepared, subjected to an activation treatment and kept in a vacuum together with a glass substrate G having a transparent electrode ITO opposing to the carbon region on an inner surface thereof; and a circuit for applying a drive voltage between the lower electrode and the upper electrode and applying an accelerating voltage to the upper electrode and the transparent electrode was connected, followed by evaluation. The evaluation of a current-voltage characteristic of the electron emission device array S was performed by measuring a device current Id flowing at the time of applying a voltage Vd between the upper metal electrode and the lower metal electrode and an emission current Ie flowing at the time when an electron is emitted to the transparent electrode from the electron emission device. An accelerating voltage Va applied between the transparent electrode and the electron emission device is 1 kV (constant).

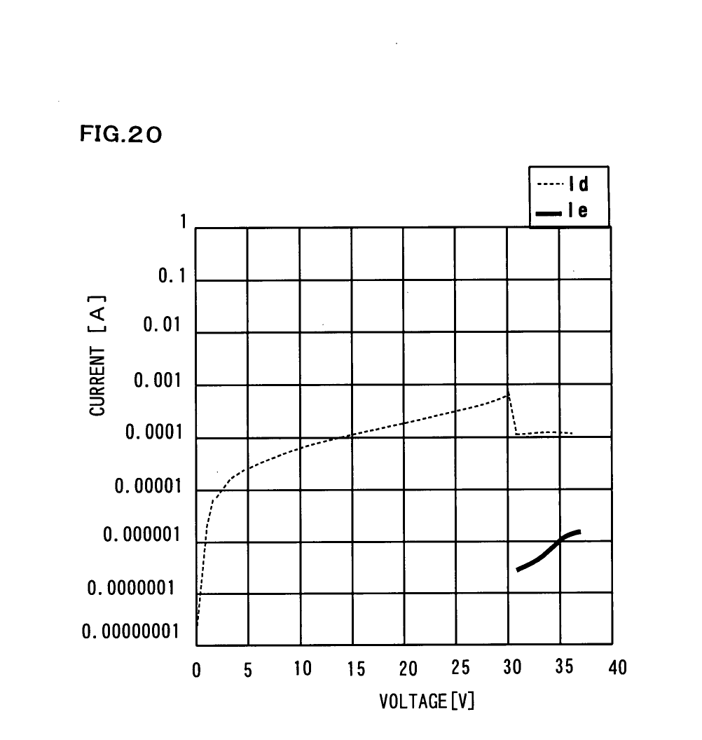

An example of a voltage-current characteristic during the activation treatment of the electron emission device of the present Example is shown in FIG. 20. Up to 37 V was applied as the voltage Vd to the electron emission device of the present Example. As shown in FIG. 20, a peak of the device current Id appeared in the vicinity of 30V, and immediately thereafter, the device current Id was largely reduced. As the device current Id was reduced, the emission current Ie was observed. Thereafter, when the voltage Vd was further increased, the device current Id remained substantially steady, and the emission current Ie further increased.

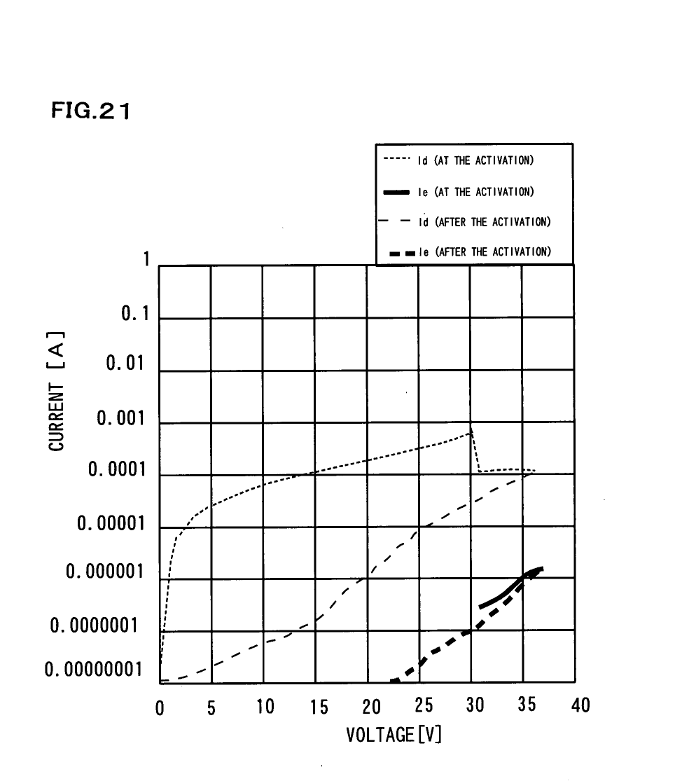

An example of a voltage-current characteristic when the voltage Vd was again applied to the electron emission device of the present Example after the activation treatment is shown in FIG. 21. Up to 37 V was applied as the voltage Vd to the electron emission device of the present embodiment likewise the case of the activation treatment. As shown in FIG. 21, as the voltage Id was increased, the device current Id increased and when the voltage Vd was 37 V, became substantially the same value as the device current value at the activation treatment. Also, the device current Id decreased over the whole, and the peak of the device current Id seen at the activation disappeared. The emission current Ie was more frequently observed at the time when the voltage Vd was low as compared with that at the activation treatment; and as the voltage Vd was increased, the emission current Ie increased and when the voltage Vd was 37 V, became substantially the same value as the emission current value at the activation treatment.

Even by repeatedly turning on electricity after the second time over and over, the electron emission device of the present Example after performing the activation treatment exhibits a current-voltage characteristic substantially the same as the current-voltage characteristic at the time of turning on electricity of the second time.

In the present Example, the concentration of B to be added in the Si layer may be other than 1.1%. The Si layer is required to have a resistivity value to some extent, and in the case where the concentration of B is too low or too high, the electron is not emitted. Accordingly, it is thought that the concentration of B is preferably from approximately 0.5% to 8.0%.

In the present Example, the thickness of the thick insulator part may be other than 300 nm. Since the thick insulator part is a layer for preventing leakage of the current in other part than the electron emission part, it is better that the thickness is thick as 100 nm or more as far as possible. However, when the thickness of the thick insulator part is too thick, the coverage of each of the thin insulator part and the upper electrode becomes problematic. Accordingly, from the standpoint that the excess of the thickness is not desired, it is preferable that the thickness of the thick insulator part is from approximately 200 to 800 nm.

In the present Example, the thickness of the thin insulator part may be other than 50 nm. The thin insulator part is a tunnel insulator layer at the time of electron emission, and the electron emission could be confirmed at a thickness of from approximately 10 to 250 nm. However, from the standpoints that when the thickness is too thin, breakage of the device is easy to occur; and that when the thickness is too thick, the electron emission amount is reduced, it is thought that the thickness of the thin insulator part is preferably from 30 to 100 nm.

In the present Example, the thickness of the upper electrode may be other than 60 nm. In the case where the thickness of the upper electrode is from approximately 10 nm to 180 nm, the electron emission could be confirmed. However, from the standpoints that when the thickness is too thin, since the coverage of the upper electrode in the difference in level is poor, the electron emission is not stable; and that when the thickness is too thick, the amount of electrons absorbed on the upper electrode becomes large, whereby the electron emission amount is reduced, it is thought that the thickness is preferably from approximately 50 to 100 nm.

In the present Example, the thickness of the carbon region may be other than 60 nm. In the case where the thickness of the carbon region is from approximately 10 to 100 nm, the electron emission is confirmed. However, even in both the case where the thickness of the carbon region is too thick and the case where it is too thin, the electron emission is not stable, and it is thought that the thickness of the carbon region is preferably from approximately 50 to 70 nm.

In the present Example, the fabrication method may be different between the thick insulator part and the thin insulator part. For example, the thick insulator part may be formed by a CVD method. In general, since a film fabricated by the CVD method is better in crystallinity than a film fabricated by a PVD method such as a sputtering method, the generation of a defect can be suppressed. For that reason, it is thought that it is possible to suppress leakage of the current in other part than the electron emission part. Above all, when SiO₂ fabricated by a plasma CVD method using TEOS as a source is used as the thick insulator part, the fabrication can be achieved at a low temperature of from approximately room temperature to 350° C. Accordingly, it is thought that it is possible to reduce influences giving to the device or the like.

Also, in the present Example, the thick insulator part and the thin insulator part may be made of a film different material from each other. For example, when SiN is used in the thick insulator part, since SiN has higher resistivity tha SiOₓ, it is thought that the insulating properties can be enhanced.

Also, in the present Example, though the outer ring of the electron emission part was formed in a circle having a diameter of 2 mm and the inner ring was formed in a circle having a diameter of 1 mm, the size of each of the outer ring and the inner ring may be other than that of the present Example. The size of each of the outer ring and the inner ring may be adjusted depending upon the use to be applied.

Also, in the present Example, though the electron emission part was formed in a circle, the shape of the electron emission part may be other than a circle. For example, since by forming the shape of the electron emission part in a star shape, a longitudinal linear shape or a cross shape, the area of the practical electron emission region can be made large, a larger emission current is obtained.

Examples of the preparation method of an electron emission device not using a micro mask include a method of chemically removing the prepared film to form a step part and a method of physically removing the prepared film to form a step part.

In the case of performing the preparation by chemical removal, there are though two kinds of wet etching and dry etching. In the Example of the present application, the outer ring is formed by wet etching, and the inner ring is formed by dry etching. Examples of advantages brought by the wet etching include points that there is no restriction in a selection ratio; that the costs are cheap; and that the productivity is high. In the case of performing the preparation by dry etching, there is thought an RIE apparatus. Examples of advantages brought by the dry etching include a point that since a generally obtained shape is anisotropic, it is possible to achieve very precise pattern control.

In the case of performing the preparation by physical removal, there are thought at least two kinds of a removal method by sputtering and a thermal removal method. In the case of performing the preparation by sputtering, there is thought a focused ion beam (FIB) method. As an advantage brought in the case of using FIB, a difference in level can be formed without using a mask. By an FIB apparatus, it is possible to accurately perform cross-sectional working of a desired place at a very high positional precision by focusing an accelerated ion beam by an electrostatic lens system, scanning a sample surface, and detecting a generated secondary electron or secondary ion and observing it as an image (SIM: scanning ion microscopy image). In the case of performing the thermal preparation, there is thought laser abrasion. Examples of advantages brought in the case of employing laser abrasion include points that the working can be achieved by using a relatively simple apparatus; that when a mask is used, a large area can be worked at once; and that the working can be achieved without using a mask.

### OTHER EXAMPLES

As Example 2, an electron emission device was prepared by fixing a thickness of the thick insulator layer and changing a thickness of the thin insulator layer and evaluated. In the present Example, the thickness of the thick insulator layer was fixed at 300 nm, and the thickness of the thin insulator layer was changed from 10 nm to 350 nm. Electron emission device arrays S of 40 mm`40 mm were prepared in the same manner as in Example 1, subjected to an activation treatment by using a measurement system as illustrated in FIG. 19 and evaluated. With respect to the contents of the evaluation, 1,000 electron emission device arrays were prepared, and during the activation treatment, a breakage rate of the electron emission device and an average emission current amount were examined. The “breakage rate of the electron emission device” as referred to herein represents how many electron emission devices were broken during the activation treatment among 1,000 electron emission devices; and the “average emission current amount” as referred to herein represents an average of the emission current amount of non-broken electron emission devices.

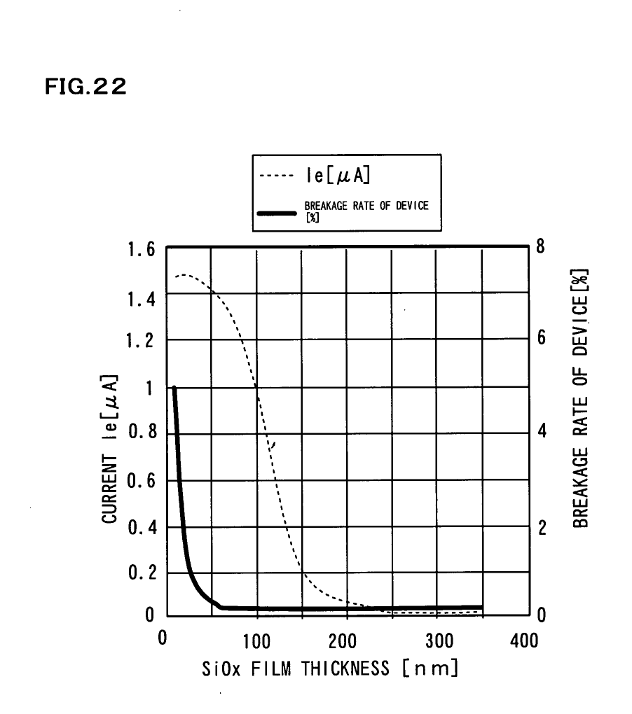

The evaluation results in the activation treatment of the electron emission device prepared in the present Example are shown in FIG. 22. In the case where the thickness of the thin insulator layer is thinner than 50 nm, though with respect to the emission current amount, values better than those in Example 1 were obtained, the breakage of the electron emission device occurred. In the case where the thickness of the thin insulator layer is thicker than 50 nm, though the breakage of the electron emission device did not substantially occur, as the thickness of the thin insulator layer became thick, the emission current amount was reduced. In the case where the thin insulator layer is thin, since the electron is easily tunneled, though the emission current amount becomes large, the electron emission device is easily affected by a defect so that the breakage rate of the electron emission device increases. Inversely, in the case where the thickness of the thin insulator layer is thick, though the electron emission device is hardly affected by a defect or a pinhole, the electron is hardly tunneled so that the emission current amount is reduced.

As Example 3, an electron emission device was prepared by fixing a thickness of the thin insulator layer and changing a thickness of the thick insulator layer and evaluated. In the present Example, the thickness of the thin insulator layer was fixed at 50 nm, and the thickness of the thick insulator layer was changed from 50 nm to 800 nm. The evaluation method is the same as in Example 2.

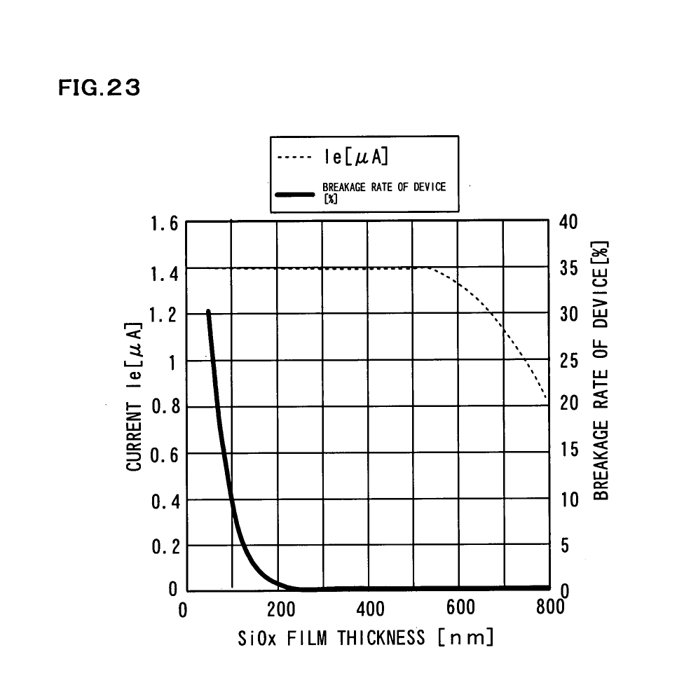

The evaluation results in the activation treatment of the electron emission device prepared in the present Example are shown in FIG. 23. In the case where the thickness of the thick insulator layer is thinner than 200 nm, the breakage of the electron emission device occurred. This is because leakage of the current was generated in other part than the electron emission part. In the case where the thickness of the thick insulator layer is thicker than 550 nm, as the thickness of the thick insulator layer became thick, the emission current amount was reduced. As reasons of the reduction of the emission current, there are numerated two points that since the thickness of the thick insulator layer was too thick, the difference in level of the outer ring of the electron emission part became excessively high so that the electron which had been once emitted was absorbed by the upper metal electrode; and that since the difference in level of the outer ring became excessively high, coverage of the upper metal electrode became worse.

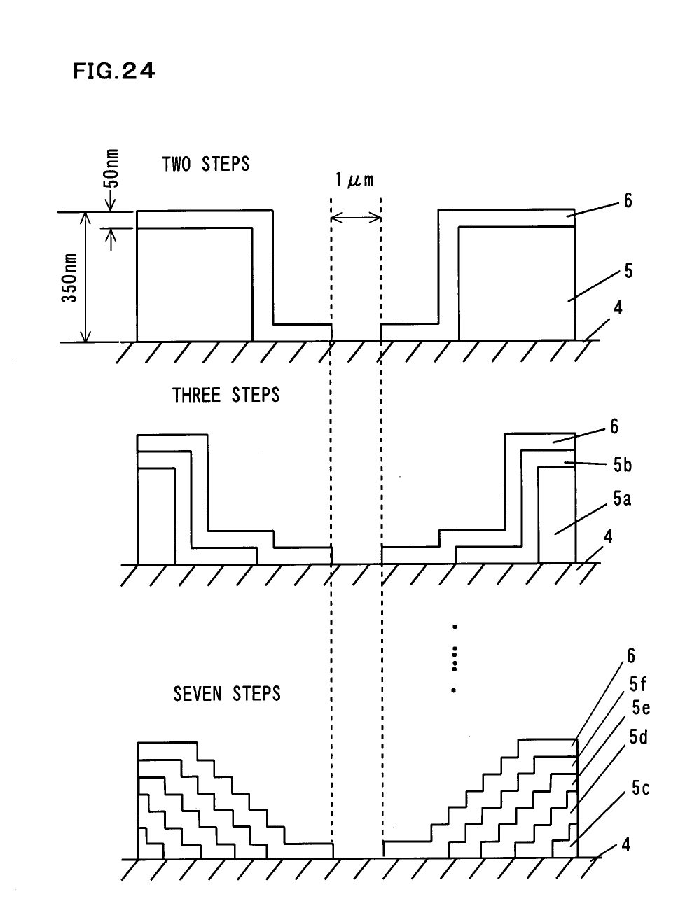

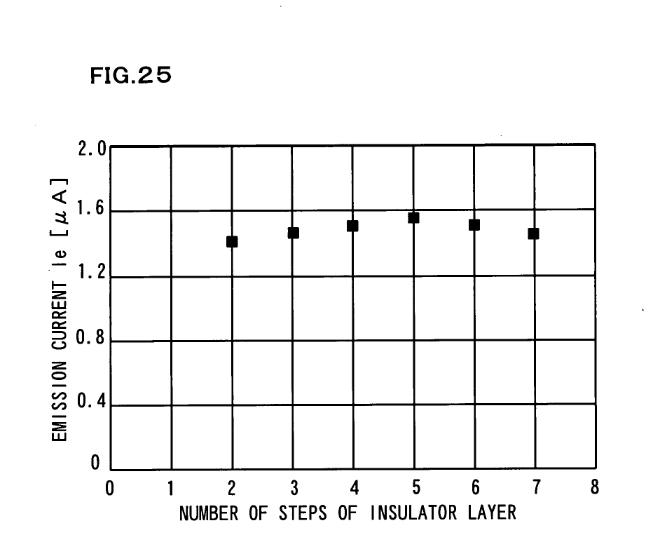

Furthermore, as Example 4, some devices were prepared by fixing the thickest portion of the insulator layer at 350 nm, fixing the thickness of the innermost ring at 50 nm and increasing the number of steps from the inner ring side at steps of 50 nm. Cross-sectional views of those electron emission devices are shown in FIG. 24. From two steps to seven steps of the devices of FIG. 24 are each composed of a thin insulator part 6 and a thick insulator part 5 or thick insulator parts 5a to 5f. Similar to the foregoing experiments, the diameters of the innermost ring are all equally 1 mm. Each of the devices was subjected to an activation treatment, and the results obtained are shown in FIG. 25 with respect to a relation of a number of steps of the insulator layer and an emission current.

Similar to the case of Example 3, in all the cases, the breakage of the device did not substantially occur at the activation. With respect to the emission current, in the case where the number of steps is two or more, a large value could be obtained in all the cases.

In the light of the above, by employing a structure in which the thickness of the insulator layer decreases in a stepped shape (two steps or more) and configuring the electron emission region to include a portion having a thin thickness of an insulator layer where tunneling of an electron is easy to occur and a portion having a thoroughly thick thickness of an insulator layer where leakage of a current hardly occurs, it is possible to prepare a device having an electron emission characteristic the same as in an electron emission device in which the thickness of the insulator layer gradually decreases without using a fine particle or a micro mask.

Also, by increasing the number of steps, it becomes possible to prevent the disconnection of the upper electrode to be fabricated on the insulator layer. Furthermore, as described in Example 1, the disconnection can be effectively prevented by forming a taper in the step part.

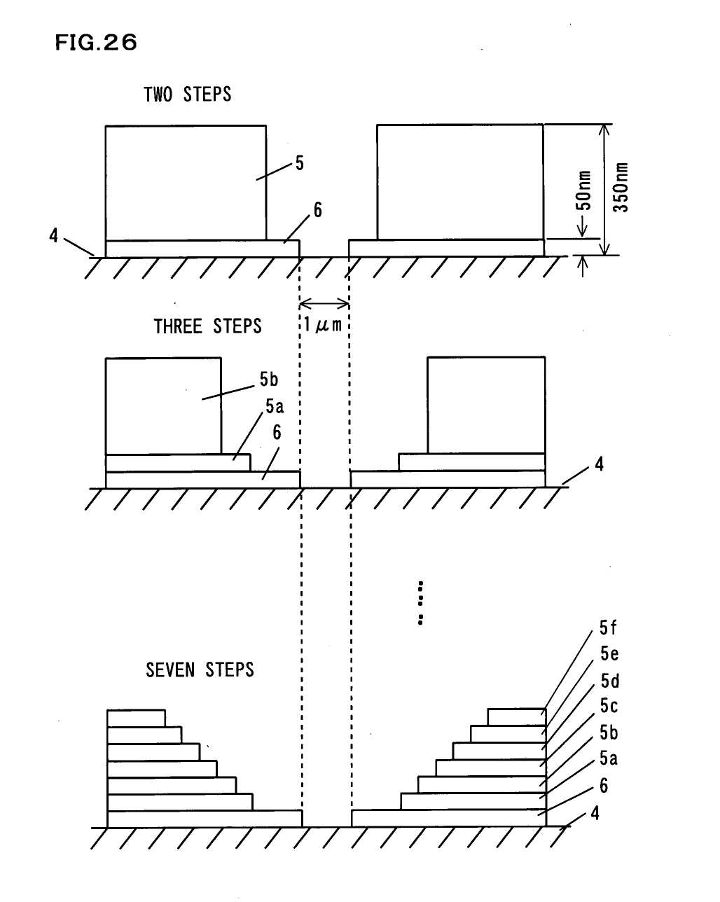

Also, as Example 5, by employing, as a structure of a device in which the thickness of the insulator layer decreases in a stepped shape, a structure in which a thin insulator part 6 having a minimum penetrating opening is previously fabricated on a side of an electron supply layer 4 and thick insulator parts 5a to 5f are successively fabricated thereon so as to have an increasing concentric penetrating opening as illustrated in FIG. 26, the same effects are obtainable, too. Furthermore, in that case, for example, even when a defect such as a through-hole is present by any chance at the stage of preparing a penetrating opening of the thick insulator part 5a, since it is covered by the insulator layers 5b, et seq., it is possible to make the presence of a through-hole extremely small at the time of completing the device. This is because though, for example, a pinhole generated from a particle adhered at the time of fabrication is estimated as the through-hole, a probability that a pinhole is formed in the same place in the fabrication of different and plural times is extremely small.

In general, since a device of an MIM or MIS structure has a structure in which an electron emission part occupying a large area within the device is composed of a stack of a thin insulating layer and a thin upper electrode, there are involved drawbacks that leakage of a current is easy to occur at the time of turning on electricity due to a defect generated at the time of preparing a device or the like; and that breakage of the device easily occurs.

However, in the electron emission device of the present embodiment, since a portion occupied by the thin insulator part which becomes the electron emission part in the area within the device is small and the other is covered by the thick insulator, a through-hole is hardly generated.

Also, since a conventional fine particle or micro mask is not used, there are brought such advantages that no contamination in a manufacturing line is caused; that the formation process of the subject micro mask or the like can be simplified; that a more precise electron emission shape can be controlled; and that excellent reproducibility of a shape or layout of the electron emission part is realized.

1. An electron emission device including a lower electrode on a near side to a substrate and an upper electrode on a far side to the substrate and an insulator layer and an electron supply layer stacked between the lower electrode and the upper electrode and emitting an electron from the upper electrode side at the time of applying a voltage between the lower electrode and the upper electrode, the device comprising:
an electron emission part provided with an opening formed by an inner wall of a stepped shape in which a thickness of the insulator layer decreases stepwise; and a carbon-containing carbon region which is connected to the upper electrode side and which is brought into contact with the insulator layer and the electron supply layer, wherein the upper electrode and the insulator layer are absent over and at a portion of the carbon-containing carbon region coming into contact with the electron supply layer, wherein the insulator layer includes a thin insulator part in which the upper electrode is terminated thereon and also terminated on the electron supply layer and a thick insulator part disposed between the thin insulator part and the electron supply layer, wherein the thin insulator layer has a thickness of from 30 to 100 nm.

2. (canceled)

3. (canceled)

4. The electron emission device according to claim 1, wherein the electron supply layer and the upper electrode come into electrical contact with each other by the carbon region.

5. The electron emission device according to claim 1, wherein, in the electron emission part, at least one of a portion where the carbon region and the electron supply layer come into contact with each other and a terminal portion of the upper electrode has a shape composed of a circle, an ellipse, an oval, a polygon, or a closed curve.

6. The electron emission device according to claim 1, wherein the electron emission part is a recess on a flat surface of the upper electrode.

7. The electron emission device according to claim 1, wherein the insulator layer is composed of a dielectric and has a thickness of 50 nm or more in other part of the electron emission part.

8. The electron emission device according to claim 1, wherein the electron supply layer is composed of an amorphous phase made of silicon or a mixture containing silicon as a major component or a compound thereof.

9. The electron emission device according to claim 8, further comprising a partially crystallized phase in the portion of the electron supplying layer coming into contact with the carbon region.

10. The electron emission device according to claim 9, wherein the crystallized phase is formed by crystallization by turning on electricity between the electron supply layer and the upper electrode.

11. The electron emission device according to claim 1, wherein, in the inner wall of a stepped shape, at least a part of the inner wall is vertical to the upper electrode or the electron supply layer.

12. The electron emission device according to claim 1, wherein, in the inner wall of a stepped shape, at least a part of the inner wall has a tapered structure.

13. An electron emission device array comprising a plurality of the electron emission devices according to claim 1.

14. A manufacturing method of an electron emission device including a lower electrode on a near side to a substrate and an upper electrode on a far side to the substrate and an insulator layer and an electron supply layer stacked between the lower electrode and the upper electrode and emitting an electron from the upper electrode side at the time of applying a voltage between the lower electrode and the upper electrode, the method comprising:
an electron emission part forming step of uniformly fabricating the insulator layer and the upper electrode, removing a part of the insulator layer and the upper electrode to decrease stepwise a thickness of the insulator layer and form an opening having an inner wall in a stepped shape, and exposing the electron supply layer; and
a carbon region forming step of fabricating a carbon-containing carbon region which is connected to the upper electrode side and which is brought into contact with the insulator layer and the electron supply layer.

15. The manufacturing method of an electron emission device according to claim 14, wherein, in the electron emission part forming step, the insulator layer is removed by employing a dry or wet etching process.

16. The manufacturing method of an electron emission device according to claim 14, wherein, in the electron emission part forming step, a focused ion beam method is employed as a measure for removing the insulator layer.

17. The manufacturing method of an electron emission device according to claim 14, wherein, in the electron emission part forming step, a laser abrasion method is employed as a measure for removing the insulator layer.

18. The manufacturing method of an electron emission device according to claim 14, wherein, in the electron emission part forming step, the insulator layer is fabricated by a multilayered structure including a thick insulator part disposed on the electron supply layer and a thin insulator part which is fabricated on the thick insulator part and in which the upper electrode is terminated thereon and also terminated on the electron supply layer.

19. The manufacturing method of an electron emission device according to claim 14, wherein the electron supply layer is composed of an amorphous phase made of silicon or a mixture containing silicon as a major component or a compound thereof; and that after the carbon region forming step, crystallization from the amorphous phase is achieved in a part of the electron supply layer by an activation treatment for applying a prescribed voltage between the upper electrode and the electron supply layer.

20. The electron emission device according to claim 1, wherein the thick insulator part and the thin insulator part are different in material from each other.

21. The manufacturing method of an electron emission device according to claim 18, wherein the thin insulator part is disposed through a physical vapor deposition (PVD) method and the thick insulator part is disposed through a chemical vapor deposition (CVD) method.
